(19) United States
(12) Patent Application Publication
(10) Pub. No.: US 2017/0267090 A1
(43) Pub. Date: Sep. 21, 2017

(54) STRUCTURE FOR FASTENING ENGINE MOUNT

(71) Applicants: Hyundai Motor Company, Seoul (KR); Kia Motors Corporation, Seoul (KR)

(72) Inventor: Hyo-Seok Kim, Gwangmyeong (KR)

(21) Appl. No.: 15/190,906

(22) Filed: Jun. 23, 2016

(30) Foreign Application Priority Data
Mar. 18, 2016 (KR) 10-2016-0032724

(51) Int. Cl. B60K 5/12

(52) U.S. Cl. CPC B60K 5/1208; B60Y 2304/05; B60Y 2304/03

(57) ABSTRACT

A structure for fastening an engine mount is provided and includes an engine bracket that is mounted on an engine body coupled to a first end of a support bracket and a second end of the support bracket is connected to the engine mount. The support bracket has a bolt aperture that receives a center bolt protruding from an upper surface of the engine mount. The support bracket is placed on a mounting seat on the upper surface of the engine mount. The mounting seat is recessed downward from the upper surface of the engine mount. The height difference between an engine side portion and an engine mount side portion is reduced to a depth of the recession of the mounting seat. The rigidity and NVH performance are improved and a weight of the support bracket is reduced by omitting the damper.

### CROSS-REFERENCE TO RELATED APPLICATIONS

This application claims priority under 35 U.S.C. §119 to Korean Patent Application No. 10-2016-0032724, filed on Mar. 18, 2016, in the Korean Intellectual Property Office, the disclosure of which is incorporated herein by reference in its entirety.

### BACKGROUND

1. Field of the Invention

The present invention relates to a structure for fastening an engine mount mounted on a vehicle body to support a load of an engine and to isolate vibration, and more particularly, to a structure for fastening an engine mount, that improves rigidity and noise, vibration, and harshness (NVH) performance by reduction of a height of a point (e.g., mounting seat) where a support bracket is fastened, and omits a damper.

2. Description of the Related Art

Generally, an engine for a vehicle is installed in an engine compartment of a vehicle body using an engine mount to isolate and attenuate vibration of the engine. In particular, in a passenger vehicle, a rubber engine mount isolates and attenuates vibration using elastic force of a rubber, a pneumatic engine mount provides damping force by allowing air to flow through a case, and a hydraulic engine mount (e.g., fluid filled engine mount) is configured to be filled with a predetermined amount of hydraulic liquid are widely used.

In the related art, a structure for fastening an engine mount as illustrated in FIG. 1A, includes a cylindrical engine mount 1 with a center bolt 1a which protrudes from an upper surface of the cylindrical engine mount 1. the cylindrical engine mount 1 is fixed to a vehicle body through fixing brackets 1b. Further, one end of a support bracket 2, which has bolt apertures 2a formed at a first and second ends of the support bracket 2, is disposed on the engine mount 1 and the center bolt 1a is inserted and fastened into the bolt aperture 2a. The support bracket 2 is fixed coupled via a plurality of nuts 4. The second end of the support bracket 2 is connected to an engine bracket 3 that extends from an engine body, and the engine mount 1 supports a load of the engine. For example, the structure as described above, the support bracket 2 is separated or fastened in a vertical direction. The stud bolts are widely used as the center bolt 1a and the bolts 3a are pre-fastened to the engine bracket 3 improve factory workability.

Therefore, when the support bracket 2 is not fastened in the vertical direction, the support bracket 2 is unable to be fitted at a point where the center bolt 1a of the engine mount 1 is fastened and at two points where the bolts 3a of the engine bracket 3 are fastened. Accordingly, the support bracket 2 is unable to be assembled. In other words, a bolt having a head may be used to fasten the support bracket 2 instead of the stud bolt by being fitted and fastened in the horizontal direction. However, an operator will have difficulty matching the position of the bolt aperture 2a formed in the support bracket 2 in an assembly line, which causes deterioration in workability and results in an increase in production costs due to an increase in working time.

In other words, as illustrated in FIG. 1B, in the structure in the related art, since the support bracket 2 is mounted in the vertical direction, a point where the support bracket 2 and the center bolt 1a are connected to each other is set to be relatively higher than a point where the support bracket 2 is fastened to the engine bracket 3. Accordingly, the rigidity is adversely affected by a height difference (see the upper drawing in FIGS. 6A-6B).

Therefore, due to the deterioration in rigidity, the thickness of the support bracket 2 increases and requires using a material having high rigidity. Further, a damper is required due to the fluctuation in resonant frequency caused by the deterioration in rigidity, and as a result, the weight and production costs increase.

The above information disclosed in this section is merely for enhancement of understanding of the background of the invention and therefore it may contain information that does not form the prior art that is already known in this country to a person of ordinary skill in the art.

### SUMMARY

The present invention provides a structure for fastening an engine mount capable of reducing a height difference between a position where a support bracket may be connected with an engine and a position where the support bracket may be connected with an engine mount when the support bracket is fastened in a vertical direction.

An exemplary embodiment of the present invention provides a structure for fastening an engine mount, in which an engine bracket mounted on an engine body may be coupled to a first end of a support bracket and a second end of the support bracket is connected to the engine mount. The support bracket may include a bolt aperture into which a center bolt that protrudes from an upper surface of the engine mount upon insertion. For example, the center bolt may be inserted into the bolt aperture and the support bracket may be disposed on the upper surface of the engine mount. A mounting seat on which the support bracket is disposed may be formed on the upper surface of the engine mount. The mounting seat may be formed in a shape recessed (e.g., to a predetermined depth) downward from the upper surface of the engine mount to be disposed lower in height than other portions of the upper surface of the engine mount.

The engine mount according to the present invention may include a core made of a metallic material and the center bolt may be coupled thereto to protrude in an upward direction. An insulator may be formed to include the core and may be made of a rubber material. A case may be coupled to the exterior of the insulator, and a part of the case may be removed (e.g., cut oft). The mounting seat may be formed at a position where a part of the insulator in a cut-out portion of the case is removed.

In the exemplary embodiment of the present invention, at the portion where the mounting seat is formed, the insulator may be recessed to a depth at which the core is exposed to the exterior, and a portion of an upper surface of the core may be cut off to form the mounting seat. To prevent an end of the case from being abraded when the insulator moves, an end of a rim of the cut-out portion of the case may be bent in an upward direction, and the bent portion may be rounded to form a circumference. A stopper may be mounted on the cut-out portion of the case and may be configured to prevent the support bracket from being lowered and to inhibit the insulator from being subject to excessive elastic deformation.

In the present invention, as the engine mount, a pneumatic engine mount, a rubber engine mount, and a hydraulic engine mount may be used. In other words, the engine mount may be a hydraulic engine mount in which a nozzle plate and a diaphragm are mounted below the insulator, an upper liquid chamber may be formed by the nozzle plate between the insulator and the nozzle plate, a lower liquid chamber may be formed between the nozzle plate and the diaphragm, and in accordance with elastic deformation of the insulator, an encapsulated hydraulic liquid may be configured to flow between the upper liquid chamber and the lower liquid chamber through a flow path formed on the nozzle plate.

The present invention may reduce a height difference between an engine side portion and an engine mount side portion as much as a depth to which the mounting seat is recessed, thereby improving rigidity and NVH performance in comparison with the structure in the related art. Accordingly, a weight of the support bracket may be reduced by omitting the damper, thereby reducing production costs and reducing a weight of the vehicle body. The stopper may be mounted on the case to prevent the insulator from being deformed over a reference value due to an excessive downward movement of the support bracket. Further, the rim of the cut-out portion of the case may be rounded to prevent the insulator from being abraded by the case when the insulator moves.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exemplary view illustrating states in which an engine mount in the related art is separated from and assembled with a support bracket and an engine bracket;

FIG. 2 is an exemplary view illustrating states in which an engine mount according to an exemplary embodiment of the present invention is separated from and assembled with a support bracket and an engine bracket;

FIG. 3 is an exemplary view illustrating the engine mount according to the exemplary embodiment of the present invention when viewed from the front side;

FIG. 4 is an exemplary enlarged view illustrating a portion where a mounting seat is formed on the engine mount according to the exemplary embodiment of the present invention;

FIG. 5 is an exemplary longitudinal cross-sectional view of the engine mount according to the exemplary embodiment of the present invention; and

FIGS. 6A-6B are exemplary views view for comparing a height difference between an engine side mounting point and an engine mount side mounting point in a fastening structure in the related art with a height difference between an engine side mounting point and an engine mount side mounting point in the fastening structure according to the present invention.

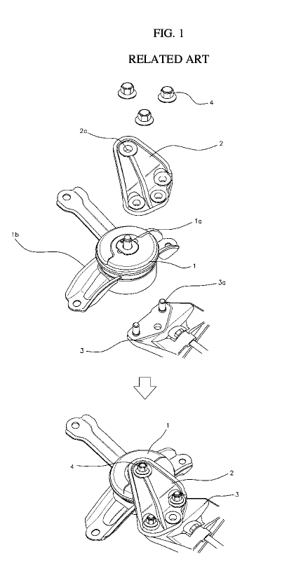

### DETAILED DESCRIPTION

Hereinafter, the present invention will be described in detail with reference to the accompanying drawings so that those skilled in the technical field to which the present invention pertains may carry out the present invention. However, the present invention may be implemented in various different ways, and is not limited to the exemplary embodiment described herein. On the contrary, the invention is intended to cover not only the exemplary embodiments, but also various alternatives, modifications, equivalents and other exemplary embodiments, which may be included within the spirit and scope of the invention as defined by the appended claims. Wherever possible, the same reference numbers will be used throughout the drawings to refer to the same or like parts.

A part irrelevant to the description will be omitted to clearly describe the present invention, and the same or similar constituent elements will be designated by the same reference numerals throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The present invention relates to a structure for fastening an engine mount in which an engine bracket mounted on an engine body may be connected to a first end of a support bracket and a second end of the support bracket may be connected to the engine mount, and hereinafter, an exemplary embodiment of the present invention will be described in more detail with reference to the drawings.

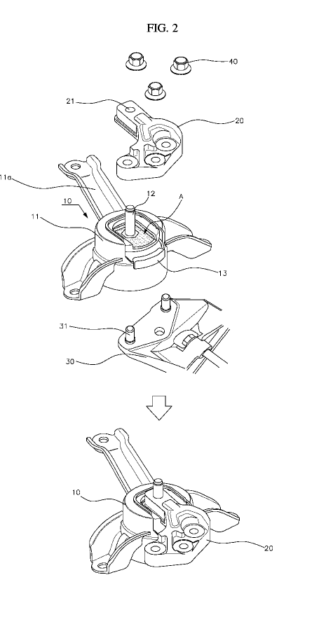

As illustrated in FIG. 2, an engine mount 10 according to the present invention may be coupled to a vehicle body member (not illustrated) via fixing brackets 11a, and may be connected with an engine bracket 30 through a support bracket 20. The support bracket 20 may include bolt apertures 21 formed at both ends thereof with a center bolt 12 that protrudes from an upper surface of the engine mount 10, and bolts 31, which are pre-fastened to the engine bracket 30, may be inserted into the bolt apertures 21. A mounting seat A on which a bottom of the support bracket 20 may be disposed when the center bolt 12 is inserted into the bolt aperture 21 of the support bracket 20 may be formed on an upper surface of the engine mount 10. The mounting seat A may be formed in a shape that is recessed (to a predetermined depth) downward from the upper surface of the engine mount 10. In other words, the mounting seat A may be disposed lower in height than other portions of the upper surface of the engine mount 10.

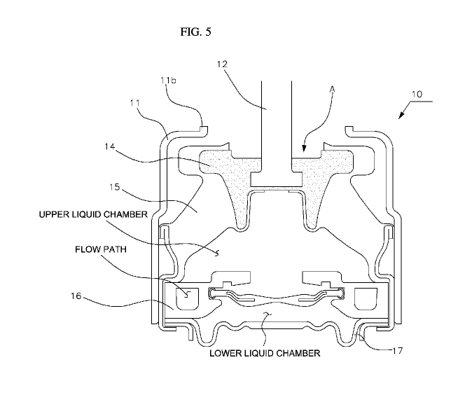

The engine mount 10 may be used regardless of the type (i.e., a pneumatic engine mount, a rubber engine mount, a hydraulic engine mount). For example, in the exemplary embodiment of the present invention, a hydraulic engine mount, filled with a hydraulic liquid, may be used. In other words, the engine mount 10 may have a nozzle plate 16 mounted between a diaphragm 17 (see FIG. 5) and an insulator 15 formed integrally with a core 14. Accordingly, an interior of the engine mount 10 may be divided into an upper liquid chamber and a lower liquid chamber. The hydraulic liquid encapsulated in the liquid chambers may be configured to flow, in accordance with elastic deformation of the insulator 15, between the upper liquid chamber and the lower liquid chamber along an annular flow path formed on the nozzle plate 16.

Referring to FIG. 5, the core 14 may be made of a metallic material, the center bolt 12 may be coupled to the core 14 s to protrude upward, and the insulator 15 may be formed in an inverted cone shape including the core 14 and made of a rubber material. Further, a metallic case 11 on which the fixing brackets 11a are mounted may be fitted with the exterior of the insulator 15. In the present invention, a portion of the case 11 may be removed (e.g., cutt off) toward a portion where the engine bracket 30 is disposed, and the mounting seat A may be formed at a position where a portion of the insulator 15 and a part of the core 14 in a cut-out portion of the case 11 are removed.

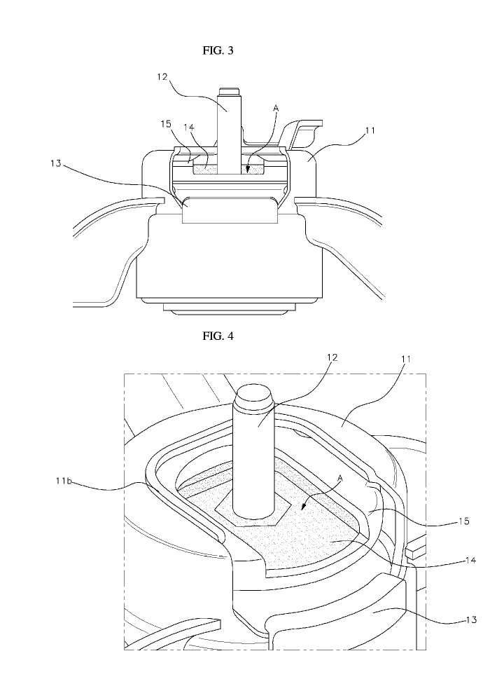

At the portion where the mounting seat A is formed, the insulator 15 may be recessed to a depth at which the core 14 is exposed to the exterior, and, a portion of an upper surface of the core 14 may be removed to form the mounting seat A. In addition, to prevent an end of the case 11 from being abraded when the insulator 15 moves by being elastically deformed upward, downward, leftward, and rightward, an end 11b of a rim of the cut-out portion of the case 11 may be bent in an upward direction, and the bent portion may be rounded to form a circumference (see FIGS. 3 to 5).

A stopper 13 may be mounted at a point vertically below the support bracket 20 at the cut-out portion of the case 11 to prevent the support bracket 20 from being lowered and may be configured to inhibit the insulator 14 from being excessively elastically deformed (e.g., to prevent the support bracket from being lowered to a predetermined distance or greater). The stopper 13 may be manufactured using a rubber material or a metallic material and then being coupled to an elastic body (e.g., rubber) to inhibit the occurrence of noise.

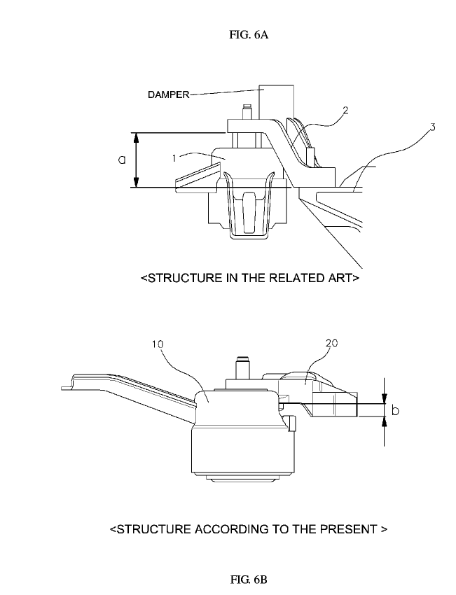

The present invention having the aforementioned configurations may reduce a height difference between an engine side portion and an engine mount side portion as much as a depth when the mounting seat A is recessed. For example, a height difference ‘a’ (approximately 60 to 65 mm) between both sides of the support bracket 2 in the structure in the related art as illustrated in FIGS. 6A-6B for the aforementioned reason. However, according to the present invention, a height difference may be reduced as much as a depth ‘b’ (approximately 20 to 30 mm) when the mounting seat A is recessed. In other words, when the engine mount 10 is fixed to the vehicle body and the engine is fixed to the second end of the support bracket 20 having a first end fixed to the engine mount 10, the support bracket 20 having the reduced height difference may more rigidly support the engine. Accordingly, rigidity may be improved in comparison with the structure in the related art, on the principle of deflection of a cantilever beam in which deflection moment applied to the cantilever beam decreases as a length of the cantilever beam decreases.

When rigidity is improved, the NVH performance may also be improved. In particular, a weight of the support bracket may be reduced by omitting the damper in the structure in the related art, thereby reducing production costs and weight of the vehicle body. Additionally, the size of engine mount may be reduced and thus manufactured more compactly. The stopper 13 may be mounted on the case 11 to prevent deformation of the insulator 15 over a reference value due to an excessive downward movement of the support bracket 20. Further, the end 11b of the rim of the cut-out portion of the case 11 may be rounded to prevent the insulator 15 from being abraded by the case 11 when the insulator 15 moves.

The present invention, which has been described above, is not limited by the aforementioned exemplary embodiment and the accompanying drawings, and it is obvious to those skilled in the art to which the present invention pertains that various substitutions, modifications and alterations may be made without departing from the spirit and scope of the invention as defined by the appended claims and can also belong to the scope of the present invention.

What is claimed is:

1. A structure for fastening an engine mount, comprising:
an engine bracket mounted on an engine body is connected to first end of a support bracket connected to and a second end of the support bracket is connected to the engine mount,
a bolt aperture of the support bracket into which a center bolt protruding from an upper surface of the engine mount is inserted,
wherein the center bolt is inserted into the bolt aperture and the support bracket is disposed on the upper surface of the engine mount, and
wherein a mounting seat on which the support bracket is placed, is formed on the upper surface of the engine mount, and the mounting seat is formed in a shape recessed downward from the upper surface of the engine mount to be disposed lower in height than other portions of the upper surface of the engine mount.

2. The structure of claim 1, wherein the engine mount includes:
a core coupled to the center bolt that protrudes in an upward direction;
an insulator that includes the core and is made of a rubber material; and
a case coupled to the exterior of the insulator, wherein a portion of the case is removed, and the mounting seat is formed at a position where a part of the insulator in a cut-out portion of the case is removed.

3. The structure of claim 2, wherein at the portion where the mounting seat is formed, the insulator is recessed to a depth at which the core is exposed to the exterior.

4. The structure of claim 3, wherein a part of an upper surface of the core is removed to form the mounting seat.

5. The structure of claim 2, wherein an end of a rim of the cut-out portion of the case is bent in an upward vertical direction, and the bent portion is rounded to form a circumference.

6. The structure of claim 5, wherein a stopper is mounted on the cut-out portion of the case and is configured to prevent the support bracket from being lowered and to inhibit the insulator from elastic deformation.

7. The structure of claim 5, wherein:
the engine mount is a hydraulic engine mount in which a nozzle plate and a diaphragm are mounted below the insulator, an upper liquid chamber is formed by the nozzle plate between the insulator and the nozzle plate, a lower liquid chamber is formed by the nozzle plate between the nozzle plate and the diaphragm, and
wherein a flow path is formed on the nozzle plate to enable an encapsulated hydraulic liquid to flow between the upper liquid chamber and the lower liquid chamber.

8. The structure of claim 3, wherein an end of a rim of the cut-out portion of the case is bent in an upward vertical direction, and the bent portion is rounded to form a circumference.

9. The structure of claim 4, wherein an end of a rim of the cut-out portion of the case is bent in an upward vertical direction, and the bent portion is rounded to form a circumference.
